(19) United States
(12) Patent Application Publication
(10) Pub. No.: US 2003/0038824 A1
(43) Pub. Date: Feb. 27, 2003

(54) Addition of mouse scrolling and hot-key functionality to biometric security fingerprint readers in notebook computers

(76) Inventor: Brian D. Ryder, Tomball, TX (US)

Correspondence Address: Michael G. Fletcher, Fletcher, Yoder & Van Someren, P.O. Box 692289, Houston, TX, 77269-2289, US

(21) Appl. No.: 09/938,784

(22) Filed: Aug. 24, 2001

(51) Int. Cl. G09G 5/00

(52) U.S. Cl. 345/684

(57) ABSTRACT

A fingerprint scanner typically performs security functions. However, a fingerprint scanner may be adapted to perform other functions, such as mouse scrolling or hot-key functions.

### BACKGROUND OF THE INVENTION

1. Field of the Invention

The present invention relates to the field of computers. Specifically, the invention relates to the control of elements on a computer display that employs a graphical user interface (GUI). More particularly, the invention relates to apparatus and methods for performing functions, launching computer applications, and selecting viewing portions of the viewable output on the computer screen using a fingerprint reader.

2. Background of the Related Art

This section is intended to introduce the reader to various aspects of art that may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Modern computers, in conjunction with the software running on them, provide users with a way to perform tasks that were previously impossible, or much more time consuming using other means to perform. Many computers that require frequent user interaction also employ a device called a graphical user interface (GUI). The GUI software code renders on the computer screen small picture icons, graphical buttons, and movable pointing markers, such as an arrow or index finger. By moving the pointing marker, the user can point to applications or functions and request that the computer launch the application or perform the function.

There are several pointing devices that can be used by a computer user to control the motions of the pointer and to select the application or function located by the pointer. One such device is a mouse. Typically, a mouse comprises a ball that rotates two wheels that represent x and y (horizontal and vertical) screen movements. The ball is secured on the underside of the mouse so that the user can roll the ball (and hence rotate the wheels) by moving the mouse across a flat surface. The wheels often have holes, through which light can be passed, spaced about the rotational axis so that a switch using light feedback can be used to sense the rotation of the wheels. This rotation is converted to a digital signal that is serially transmitted to the computer through either a wired or wireless connection. The computer uses the signal to position the pointer on the screen. To select an application or function, the mouse also comprises at least one button that the user can press to select the application or function to which the pointer is pointing.

One option available on a mouse is the inclusion of one or more additional wheels that are controlled by the user's finger movements. Rotating these wheels can perform functions such as scroll and zoom if the software running on the computer is designed for use with such a mouse. Often when running a computer application, there is more data than can be displayed on the screen at one time. In other words, the application has more data than it can make available to the user. Using the zoom function, the user can request that the computer display the displayable information in a larger or smaller format depending on whether the user would like a more detailed view of a smaller amount of displayable data or a general overview of a larger amount of displayable data. The scroll function allows the user, without changing the resolution of the viewable data, to view different parts of the data.

One problem with a mouse is the physical space needed to use the mouse. Typically a mouse is sized such that it comfortably fits the user's hand. As can be appreciated, a mouse that is too small would be cumbersome and difficult to use. Additionally, the mouse needs a flat surface on which to move. Such size requirements are especially burdensome in laptop computer applications.

Laptop computers are designed to incorporate as many of the computer parts as possible into a single unit occupying a small amount of space. In fact, much of a laptop computer's space and size requirements are limited by the users who use them. Human limitations require that the display screen, keyboard keys, and pointing devices be no smaller than a certain size. The space requirement might be further increased if there is a need to dedicate individual keys or buttons to one specific task such a launching an application or performing some function associated with an application running on the computer.

One advance in pointing device technology in laptops is the use of touch pads instead of a conventional mouse. A touch pad is a touch sensitive rectangle of material usually placed at the bottom of the keyboard. The touch pad translates finger movements on the pad to x and y movements and places them in a digital format that is sent to the processing portion of the computer in much the same way as described for a mouse above. Using this technology, the pointing device is no longer limited to a size that is comfortable for the user's entire hand, but needs only be sufficiently large to accommodate a finger and some movement. To implement the functionality of the mouse buttons, the touch pad allows the user to tap the pad or to use additional buttons associated with the touch pad. To implement the scrolling and zoom functions, the outer edges of the touch pad may be reserved so that movement in those areas invokes the scroll or zoom functions as described above in the mouse context. One problem with this solution is that inadvertent touching of the outer edge of the pad can result in undesired scrolling or zooming.

Still another solution to the size constraints for laptop pointing devices is a pointing stick. A pointing stick is placed among the keys on a keyboard and looks much like a pencil eraser. The pointing stick operates much like a joystick in that when the user presses the pointing stick in a certain direction, such pressure causes the screen pointer to move in that direction. The speed of motion of the screen pointer can be controlled by the amount of pressure placed on the pointing stick. Buttons with the same functionality as the mouse buttons described above are placed below the keyboard. There are currently no known hardware solutions to perform the scroll and zoom functions using a pointing device.

Similar to the proliferation and evolution of pointing devices, computer security has also become increasingly more important in recent times. Computers, including home and personal computers, now store a large amount of confidential information. To protect this information, access to a computer can be restricted to authorized users.

One method of restricting access is by using a physical key that acts as an electronic switch. Without the key, the computer cannot be powered on. One disadvantage to this system is that it requires the user to maintain access to the key. Additionally, users who are not authorized to use the computer system may come into possession of the key and thereby be able to access the computer system. Further still, if an authorized user intends to protect the system, they must shut down the entire system when they are finished, because the key controls the power to the overall system.

A second method of computer system protection involves the use of passwords. When a computer system is powered on, among other things, the system will load into hardware the software required for the system to function. Because this loading of software into the hardware requires several steps, one of the steps can require the user to type a password before the system will continue loading the required software. If the user is not able to type the correct password, the system will not complete the software loading, and the computer will be unavailable for use. During use, the computer may also require additional passwords for the user to access certain data files. Also, when the computer has been idle for a period of time, the system may require the user to enter a password to regain control of the system. One problem with passwords is that an authorized user may be blocked from the system if they forget or loose the password. Additionally, if an unauthorized user comes into possession of the password, they may be able to access the system.

A third method of computer security is through the use of biometrics, and more particularly, through fingerprint identification. Functionally, access to computer resources are granted in a fingerprint identification scheme in much the same way as in a password scheme. However, instead of supplying a password, the user places an appropriate finger on a fingerprint reader that compares the loops, arches, and whorls with previously stored data representing an authorized user's fingerprints. Barring bodily mutilation, an authorized user always has a key or password, and unauthorized users cannot come into possession of the key or password.

One common way of acquiring the fingerprint image is by using a CCD camera that takes a photograph of the fingerprint and stores it as a digital photo. One problem with adding a fingerprint reader to a computer system is that it is an additional piece of hardware dedicated to only acquiring fingerprint images. Adding pieces of hardware compromises the goal of minimizing computer size.

### BRIEF DESCRIPTION OF THE DRAWINGS

The foregoing and other advantages of the invention will become apparent upon reading the following detailed description and upon reference to the drawings in which:

FIG. 1 illustrates a block diagram of a computer system and associated peripheral devices;

FIG. 2 illustrates a top view of a fingerprint reader;

FIG. 3 illustrates a cross section of the fingerprint reader in FIG. 2;

FIG. 4 illustrates a detailed block diagram of a computer system;

FIG. 5A illustrates a representation of the amount of displayable data actually displayed on a computer display depending on the user's input;

FIG. 5B illustrates a computer display using a graphical user interface for selecting applications;

FIG. 6 is a flowchart illustrating the operation of scrolling and hot key functions using a fingerprint reader;

FIGS. 7A, 7B, and 7C are flowcharts illustrating sensing routines for determining the function of fingerprint reader data; and

FIG. 8 is a flow chart illustrating a method of determining movement direction and velocity of a finger on a fingerprint reader.

### DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

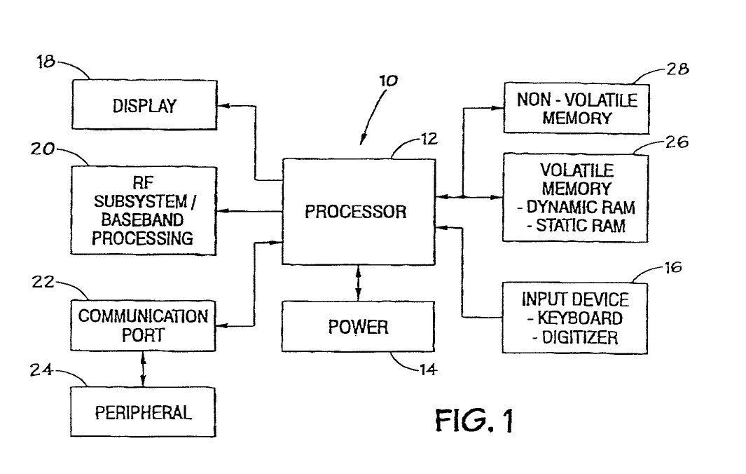

Turning now to the drawings, and referring initially to FIG. 1, a block diagram depicting an exemplary processor-based device, generally designated by the reference numeral 10, is illustrated. The device 10 may be any of a variety of different types, such as a computer, pager, cellular telephone, personal organizer, control circuit, etc. In a typical processor-based device, a processor 12, such as a microprocessor, controls many of the functions of the device 10.

The device 10 typically includes a power supply 14. For instance, if the device 10 is portable, the power supply 14 would advantageously include permanent batteries, replaceable batteries, and/or rechargeable batteries. The power supply 14 may also include an A/C adapter, so that the device may be plugged into a wall outlet, for instance. In fact, the power supply 14 may also include a D/C adapter, so that the device 10 may be plugged into a vehicle's cigarette lighter, for instance.

Various other devices may be coupled to the processor 12, depending upon the functions that the device 10 performs. For instance, a user interface 16 may be coupled to the processor 12. The user interface 16 may include an input device, such as buttons, switches, a keyboard, a light pin, a mouse, a fingerprint reader, and/or a voice recognition system, for instance. A display 18 may also be coupled to the processor 12. The display 18 may include an LCD display, a CRT, LEDs, and/or an audio display. Furthermore, an RF subsystem/baseband processor 20 may also be coupled to the processor 12. The RF subsystem/baseband processor 20 may include an antenna that is coupled to an RF receiver and to an RF transmitter (not shown). A communication port 22 may also be coupled to the processor 12. The communication port 22 may be adapted to be coupled to a peripheral device 24, such as a modem, a printer, or a computer, for instance, or to a network, such as a local area network or the Internet.

Because the processor 12 controls the functioning of the device 10 generally under the control of software programming, memory is coupled to the processor 12 to store and facilitate execution of the software program. For instance, the processor 12 may be coupled to volatile memory 26, which may include dynamic random access memory (DRAM), static random access memory (SRAM), Double Data Rate (DDR) memory, etc. The processor 12 may also be coupled to non-volatile memory 28. The non-volatile memory 28 may include a read only memory (ROM), such as an EPROM or Flash Memory, to be used in conjunction with the volatile memory. The size of the ROM is typically selected to be just large enough to store any necessary operating system, application programs, and fixed data. The volatile memory, on the other hand, is typically quite large so that it can store dynamically loaded applications. Additionally, the non-volatile memory 28 may include a high capacity memory such as a disk drive, tape drive memory, CD ROM drive, DVD, read/write CD ROM drive, and/or a floppy disk drive.

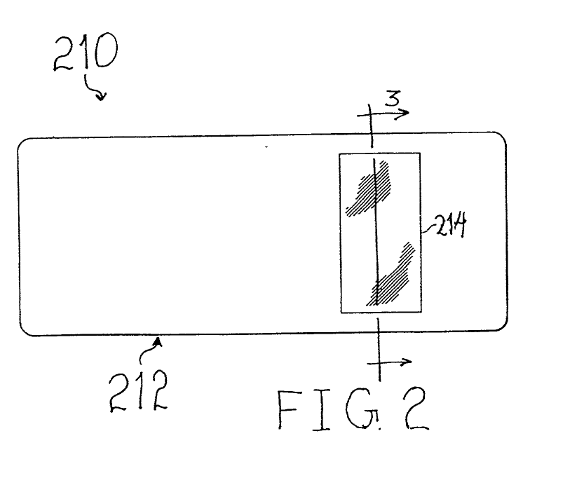

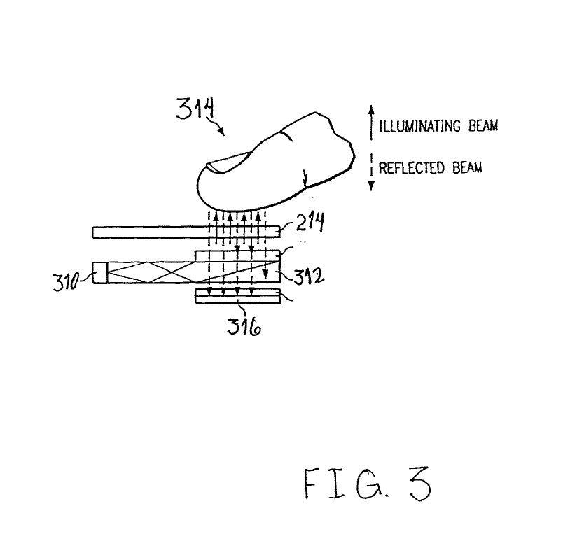

Turning now to FIGS. 2 and 3, which are drawings of a fingerprint reader 210, an apparatus for fingerprint scanning is illustrated. The exterior of the fingerprint reader 210 may comprise a fingerprint reader case 212 and a platen 214. The platen 214 may be comprised of glass, acrylic, or any other transparent material. As illustrated in FIG. 3, a laser diode 310 emits a light beam that travels down a waveguide substrate 312. The light beam is reflected such that it illuminates the platen 214 as well as a user's finger 314 placed over the platen 214. It should be noted that the present embodiment is not limited only to a finger being used as any other unique pattern, such as palm print, toe print, pore arrangement, etc., may be used. The light beam is reflected off of the user's finger 314 through the waveguide substrate 312 and onto a CCD array 316. The CCD array 316 comprises a silicon substrate that translates light into electrical signals. In this way, the CCD array 316 creates a digital image corresponding to the fingerprint on the user's finger 314. If the fingerprint scanner is coupled to a computer systems such as the device 10 described above, these digital images can be sent to the processor 12 where they can be subsequently stored in memory 26 for later use.

The fingerprint reader 212 can be configured so that it acquires a series of sequential digital images during a predetermined time period. By comparing the train of sequential images and using the time between the acquiring of individual images, the processor 12 can generate position and velocity vectors corresponding to movement of the user's finger 314 on the platen 214. In comparing the individual images, the processor 12 can look for changes in specific fingerprint patterns across the array. Alternatively, the comparison could be of the movement of the fingerprint boundary.

Because the fingerprint reader 212 compares the acquired images, the fingerprint reader 212 may be configured to perform a security function while simultaneously generating position and velocity vectors. For example, only an authorized user would be able to use the scanner to input position and velocity information into a system via the fingerprint reader 212.

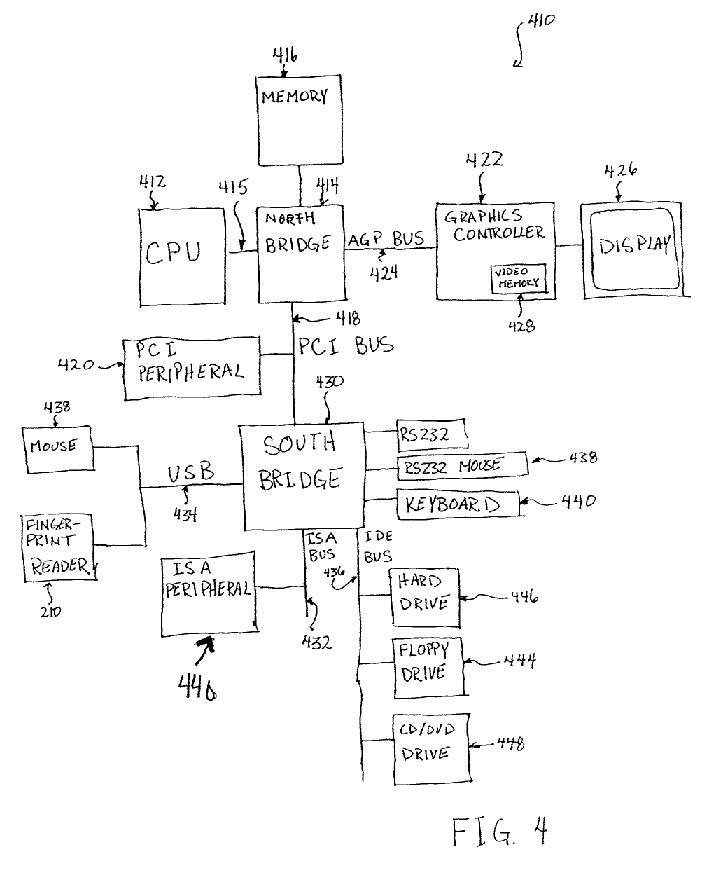

Turning now to FIG. 4, a detailed block diagram of a typical computer system 410 that implements the fingerprint scanning function in conjunction with other computer functions, is illustrated. The computer system 410 comprises a processor 412 that is coupled to numerous other components through a first bridge unit 414 (often referred to as a north bridge). The processor 412 and first bridge unit 414 are coupled through a processor bus 415. It should also be noted that the computer system 410 is not limited to a single processor and that multiple processors may be coupled to the processor bus 415 or to similar processor busses.

The first bridge unit 414 is coupled to a system memory 416 that stores the computer operating system (not specifically shown), other software applications, and data used in conjunction with the software applications and system functions. The system memory 416 comprises any one of the readily available memory types such as DRAM, SDRAM, and EDO DRAM, or any other type that may become available in the future for use with a typical computer system. On handheld and portable systems, system memory may also comprise flash memory.

A graphics controller 422 may be coupled to the first bridge unit 414 through a graphics bus 424, such as an AGP bus. Alternatively, the graphics controller 422 may be coupled to an expansion bus 418 as a PCI Peripheral 420 described more fully below. The graphics controller 422 generates video signals that are transmitted to a display 426. The display 426 comprises any one of a CRT, TFT, LCD, or any other type of display suitable for such an application. Information available for display may be stored in a video memory 428, which is coupled directly to the graphics controller 422. Alternatively or simultaneously, the same or other information available for display may be stored in an allocated portion of the system memory 416. The graphics controller 422 is generally able to retrieve displayable information from the system memory 416 through the first bridge unit 414 without directly accessing the processor 412. This allows large detailed images to be displayed quickly.

Coupled to the first bridge unit 414 is an expansion bus 418. In the preferred embodiment, the expansion bus 414 comprises a peripheral component interconnect (PCI) bus. The expansion bus 414 comprises a means for coupling a plurality of first peripheral devices 420. The first peripheral devices may comprise, video cards, network interface cards, sound cards, modems, SCSI interface cards, PCMCIA cards, or any other type of card developed for such a use.

The expansion bus 418 is also coupled to a second bridge unit 430, often referred to as a south bridge. The second bridge unit 430 couples the system 410 to secondary expansion busses. Such busses may include, but are not limited to, ISA, USB, and IDE. Shown in FIG. 4 are an ISA expansion bus 432, a USB 434, and an IDE bus 436. Additionally, the second bridge unit 430 may connect to ports that communicate using RS232 protocol. Such protocol allows for the coupling of devices like a mouse 438, a keyboard 440, or a serial communication cable (not shown) to the computer system 410. Alternatively, the mouse 438 or keyboard 440 could be connected through the USB 434 if configured for such a connection.

The mouse 438 measures the movement of the mouse across a flat surface. Additionally, the mouse 438 comprises at least one hardware button for selecting functions or applications. This selection is often referred to as “clicking” or “double clicking” depending on how the button is actuated. The keyboard may include several keys including keys representing each letter of the alphabet. Additionally, the keyboard may include alternate select keys (“shift”, “ctrl”, “alt”) that when used in conjunction with the other keys on the keyboard add further functionality. Keyboard manufacturers have also recently added keys for launching and controlling specific applications. For example, using a dedicated key, a user is able to launch email, a web browser, or other applications.

The ISA expansion bus 432 may be coupled to a plurality of ISA peripherals 440 such as modems, sound cards, and other devices configured for such an interface. The USB bus may be coupled to such devices as a mouse, keyboard, fingerprint reader, printer, scanner, external storage drive, etc. Shown in the FIG. 4 is a coupling to a fingerprint reader 210. The fingerprint reader 210 may also be disposed on the mouse 438 or the keyboard 440. Alternatively, the fingerprint reader 210 could be coupled to other buses in the system 410, such as the expansion bus 418 and the ISA expansion bus 432. For example, the fingerprint reader 210 may be disposed on a PCMCIA card (not shown) that couples directly to the expansion bus 418. The IDE bus 436 may be coupled to devices such as floppy drives, hard drives, CD ROMs, or DVD ROMs. Shown in FIG. 4 are a floppy drive 444, a hard drive 446, and a CD/DVD ROM 448.

Referring still to FIGS. 2, 3 and 4, power may be supplied to the computer system 410 through the power supply 14. Controlled by a POST routine in the non-volatile memory 28, the processor 412 enables the hard drive 446 and begins to load the operating system (not represented) into to the system memory 416 from the hard drive 446. This process is sometimes called a boot routine. As a condition to completing the boot routine, the computer system 410 may require a user to provide some type of security feedback in the form of a password or fingerprint scan. As illustrated, the fingerprint reader 210 is coupled to the USB 434. When the system 410 prompts the user for security feedback, the user may provide the security feedback by placing the user's finger 314 on the platen 214. The fingerprint reader 210 then generates a digital image of the user's fingerprint and sends the image to the processor 412. The processor 412 compares the digital image with a digital image stored on the hard drive 446 or in some other storage location. If the image of the user's fingerprint matches a stored image where such stored image represents individuals to whom access to the system 410 may be granted, the computer system 410 continues to boot.

Stored in the system memory 416 are drivers, which are modules of code that translate information from system devices into information that is usable by the processor 412 in controlling system functions. For example, in the case of a mouse, the mouse 438 sends data representing the mouse's position to the processor via the USB 434. The processor 412 then executes the driver code using data from the mouse 438 as input. The driver makes the mouse position available to any software applications that are running, including the operating system. These software applications use other drivers to place into system memory 416, and more particularly into the portion of system memory 416 allocated for graphics output, data representing a change in the displayed data based on the mouse 438 data.

The mouse 438 may also comprise scrolling inputs that represent scroll and zoom commands. These inputs often function based on the movement of a scrolling wheel. Applications that are programmed with scrolling or zoom functionality can use scrolling input from the mouse to change the data that is output to the display 426. For example, an application may have certain data that it has available for display to the user. The data may represent in one example multiple pages of text. Because the display 426 is not large enough to display all of the available text, only a portion of the text is displayed. Using the scroll function on the mouse 438, the user can request that different portions of the available text be sent to the display 426. In a zoom example, if the computer application displays graphic images in which details of the image are not available if the entire image is rendered on the display 426, the user can control magnification and demagnification of the image based on the users need by using the mouse zoom wheel.

If the mouse does not accept a scrolling function, another option is available. Once the user has finished using the fingerprint reader 210 for security purposes after the boot, the fingerprint reader 210 can be configured to function as a scrolling/zoom device, a hot-key device, and a function select device. Configuring the fingerprint reader 210 generally involves the processor 412 running a software driver that compares a continuous stream of images acquired from the fingerprint reader 210 at a specific interval to determine identity, position, speed of movement, and direction of movement of the user's finger 314. The software driver translates this information and uses it to perform the scroll/zoom, hot-key, and function select options. Alternatively, firmware in the fingerprint reader 210 could be configured to deliver position, speed of movement and direction of movement to the processor 412. A software driver being run by the processor 412 to perform scroll and zoom functions could use this information. If the computer system 410 has a need to perform a security function again, a driver that interprets data from the fingerprint reader 210 for security purposes can be invoked. When the fingerprint reader 210 is not needed for security purposes, the scroll/zoom driver described above can be reinvoked.

The fingerprint reader 210 also may be used, for example, in applications involving a headless server (not represented). In the headless server application, security is often of ultimate importance. The headless server application is therefore an ideal situation where the fingerprint reader 210 might be configured to perform a security function simultaneously with any of the scroll, zoom, and hot-key functions. A headless server is a computer system such as the computer system 410 described above except without dedicated peripherals such as the display 426, the mouse 438, and the keyboard 440. In a typical embodiment, the headless server is disposed among several other headless servers in a rack. These headless servers require only periodic interaction with a network administrator such that in the interest of economic and spatial efficiency, the peripherals are not included for each headless server. Instead, a single display 426, pointing device such as mouse 438, and keyboard 440 are configured such that they can be used for any and all of the headless servers disposed in a given location. Such a display, keyboard, mouse configuration is often referred to as a dumb terminal. In one embodiment, a fingerprint reader 210 is disposed as an integral part of the dumb terminal. In this way, the fingerprint terminal 210 can be used as a security device to protect the collection of servers from tampering as well as a space saving device such that separate hardware for scroll, zoom, and hot-key, and even pointing functions, could be eliminated.

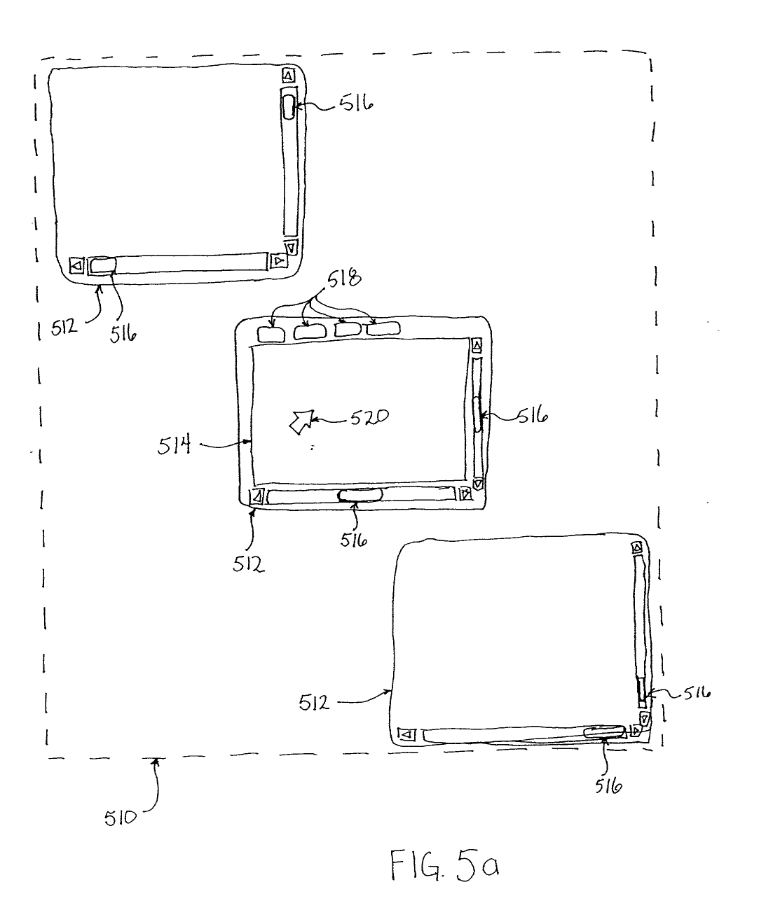

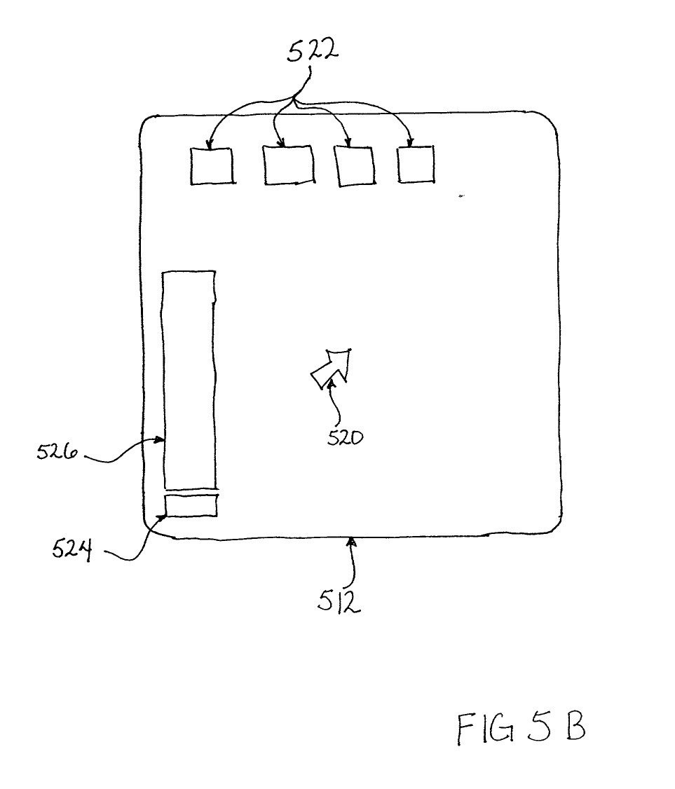

Referring now to FIG. 5, which illustrates viewable data available from a computer application as well as a device for viewing the available date, other aspects of the invention will now be explained. Viewable data 510 represents the data that a computer program has available to be rendered in a useable format on the display 426. As explained above, computer applications often have much more data available to the user than can be rendered on the display 426 at one time. A screen 512 represents the view a user might see on the display 426 when a computer application is displaying data. The displayed data 514 represents that portion of the viewable data 510 that the user has selected for viewing and that appears on the display 426.

The sliders 516 represent a GUI tool that allows the user to select a portion of the viewable data 510 for display. Also displayed on the screen 512 are function buttons 518 that represent GUI tools that allow a user, using pointing device selection functionality, to select a function associated with the application quickly. Such functions might include printing, saving, opening, or various other tools as might exist in computer applications.

Functions do not necessarily need to be activated by selection of a function button 518, but can often be selected by using hot-keys. A hot-key allows the user to press either a single key or a combination of keys to invoke a function. For example, one such hot key might perform the print function when a user simultaneously presses the “ctrl” and “p” keys on a keyboard 440. Because functions do not necessarily require graphical interaction to be invoked, the function buttons 518 may only represent a portion of the available functions, or there may be no function buttons 518 whatsoever.

Another GUI tool is a pointer 520 that can be used in conjunction with mouse input to select a function button 518 or to move the slider 516. The pointer 520 is a graphical image shaped like an arrow, index finger, or any other suitable graphic. Using a pointing device (such as a mouse), the pointer 520 can be positioned at different locations on the screen 512. The user can select a function button 518 by moving the pointer 520 over the function button 518 and pressing the hardware button on the pointing device.

The displayed data 514 may be selected by using the mouse 438 to control the pointer 520 in selecting a position for the horizontal and vertical sliders 516. Additionally, using a scrolling wheel disposed on a pointing device, one or both sliders 516 may be positioned by rotating the wheel about its rotational axis. Also, application functions may be selected by positioning the pointer 520 over a function button 518 and selecting the function by “clicking” a hardware button on the mouse 438. Alternatively, hot-keys may be used to select a particular function.

During periods of time when the fingerprint reader 210 is not needed for security purposes, it can be used to perform scroll, zoom, and hot-key functions. As outlined above, software drivers run by the processor 412 or firmware in the fingerprint reader 210 itself can be invoked to interpret fingerprint reader 210 data to be used for such purposes.

In this example, the fingerprint reader 210 is configured such that the user can control the sliders 516 and hence select appropriate portions of the viewable data 510 to be displayed as displayed data 514. Based on the movements of the user's finger 314 across the platen 214, the fingerprint reader 210 driver is able to determine when it is appropriate to switch the fingerprint reader 210 into a hot-key mode. In the hot-key mode, the user can select a particular function by placing an appropriate user's finger 314 on the platen 214. So for example, if the user placed the index finger 314 on the platen 214, the software might invoke the print function. The thumb 314 might correspond to the save function, and so forth. Each of the user's fingers 314 can be programmed to perform different functions in different applications. For example, even when the index finger is selected to perform the print function in a word processing application, it may be chosen to perform the save function in a spreadsheet application.

There are several methods for switching the fingerprint reader 210 between the scroll mode and the hot-key mode. In one such method, the user presses a key on the keyboard 440 while simultaneously placing a user's finger 314 on the platen 214. Another method compares an image generated by scanning the user's finger 314 with a collection of stored fingerprint images representing functions. If the user's finger 314 fingerprint image does not match any of the function images, the driver assumes that the fingerprint reader 210 is in scroll mode. Otherwise, the driver performs the function associated with the matching function image. Further still another method of switching to hot-key mode monitors the user's finger 314 for tapping. In other words, if the user quickly removes the user's finger 314 from the platen 214 and then quickly replaces the user's finger 314 on the platen 214, the fingerprint reader 210 will switch to hot-key mode and will perform the function associated with the user's finger 314 on the platen 214.

FIG. 5B, represents a screen that might be displayed when a user wants to request that a certain application be activated. The screen 512 has several GUI tools including a collection of program icons 522. The program icons 522 are implemented in a manner similar to the function buttons 518 described above. Currently, a user may select a computer application by moving the pointer 520 over the program icon 522 representing the application that the user wishes to invoke and by clicking the mouse 438 hardware button. Another GUI tool currently used is a menu select button 524. By using the mouse 438 and pointer 520, a user can select the menu select button 524, which will cause an application menu 526 to be displayed. The user can then use the mouse 438 and pointer 520 as described above to select an application for the computer system 410 to implement.

In accordance with the illustrated embodiment, the fingerprint reader 210 is configured such that different user's fingers 314 correspond to an application. For example, placing the index user's finger 314 on the platen 214 may invoke a word processing application on the computer system 410, the middle user's finger 314 might invoke a web browser when placed on the platen 214, and so forth.

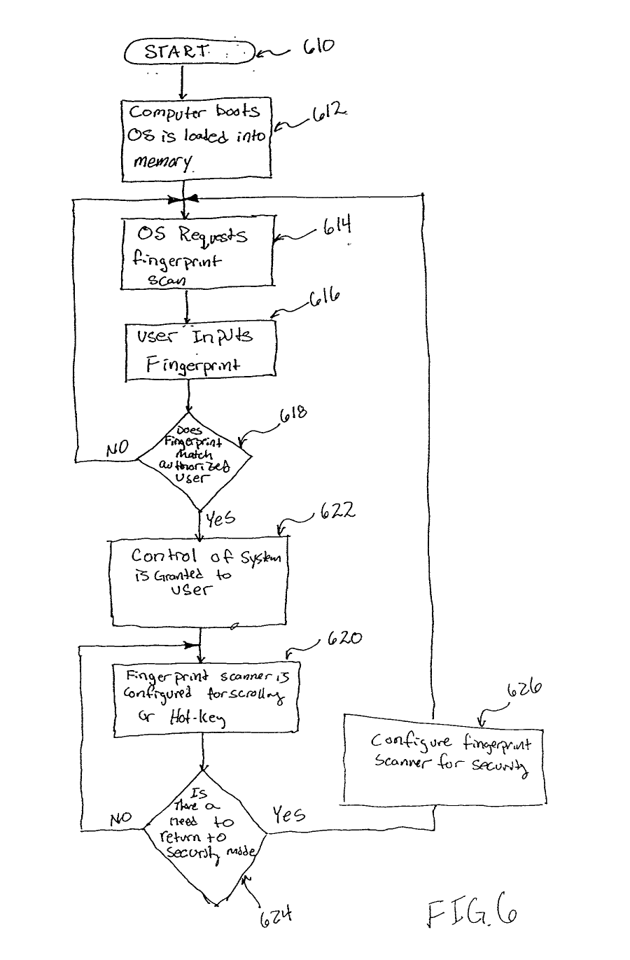

FIG. 6 is a flow chart 600 illustrating an example of the manner in which the fingerprint reader 210 may be switched between the security made and the scrolling and/or hot-key mode. The flow chart begins with a start bubble 610. The start bubble 610 might represent, among other things, an action by the user, such as powering on the computer system 410. Next, the computer system 410 boots as illustrated in the boot step 612. During the boot step 612, the computer system 410 loads appropriate parts of the operating system 410 from the hard drive to the main memory. Also, the fingerprint reader 210 is configured to function in security mode, which means that input from the fingerprint reader 210 is used in a manner consistent with a password. The system 410 then moves to a scan request step 614. In the scan request step 614, the computer system 410 prompts the user to input a fingerprint for security purposes. The computer system 410 then moves to the user input step 616. During the user input step 616, the user places an appropriate finger on the fingerprint reader 210. The fingerprint reader 210 acquires a digital image of the user's fingerprint. In the comparison step 618, the acquired fingerprint image is compared with one or more previously scanned images of fingerprints representing those who should be granted access to the computer system 410. If the acquired fingerprint does not match any of the previously scanned images, the computer system 410 goes back to the scan request step 614. The system 410 continues in this loop until a matching fingerprint image is acquired.

When a matching fingerprint is acquired, the computer system 410 moves to a control granting step 622. In the control granting step 622, control of the computer system 410 is yielded to the authorized computer user. The computer system 410 then moves to the scrolling configuration step 620. In the scrolling configuration step 620, the computer system 410 configures the fingerprint reader 210 to function as a scroll, zoom, and/or hot-key device. This configuration is usually done by associating the fingerprint reader 210 with an appropriate driver that is stored in the main memory. The computer system 410 continuously monitors the system 410 for a need to return the fingerprint reader to a security mode in the security decision step 624. There are several reasons that a computer may need to return to a security mode. One reason might be that the user is trying to access files either on a network or stored on the computer that have been additionally protected. Another reason might be that the computer has been left idle for a period of time, and the computer system 410 may want to verify that a user subsequent to the idle period is still an authorized user. In any case, if there is no need to return to security mode, the fingerprint reader will continue to be configured to function as a scroll, zoom, or hot-key device while the user has control of the computer system 410. If there is a need for the computer system 410 to return to security mode, the computer system 410 will move to the security configuration step 626. In the security configuration step 626, the fingerprint reader 210 is again associated with drivers that are used to acquire a digital fingerprint image. The computer system 410 them moves to the scan request step 614 as described above.

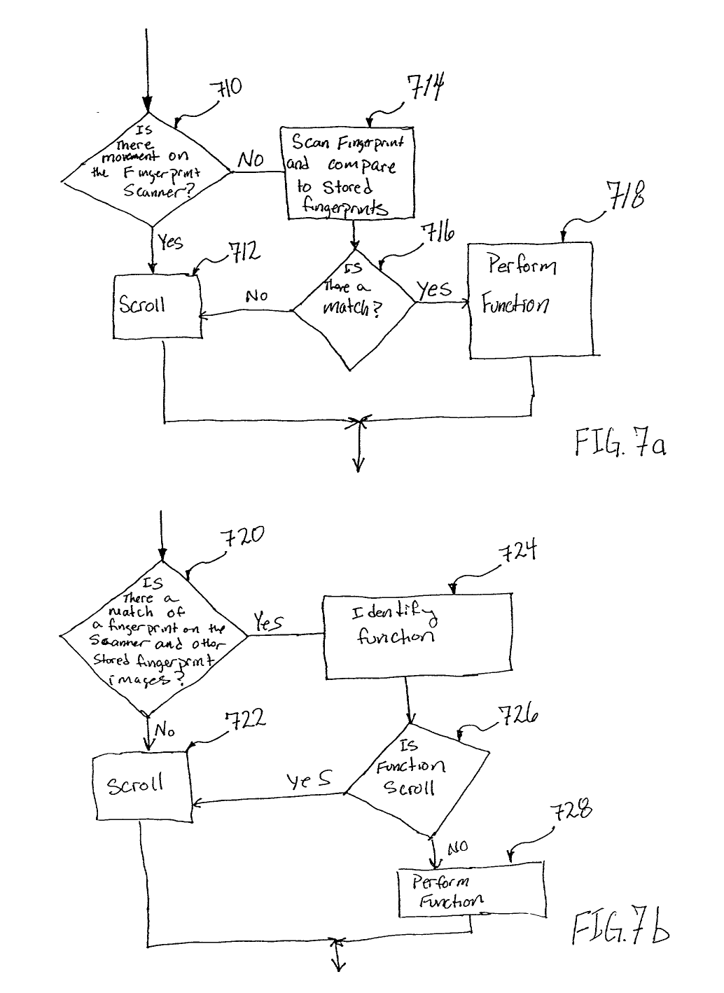

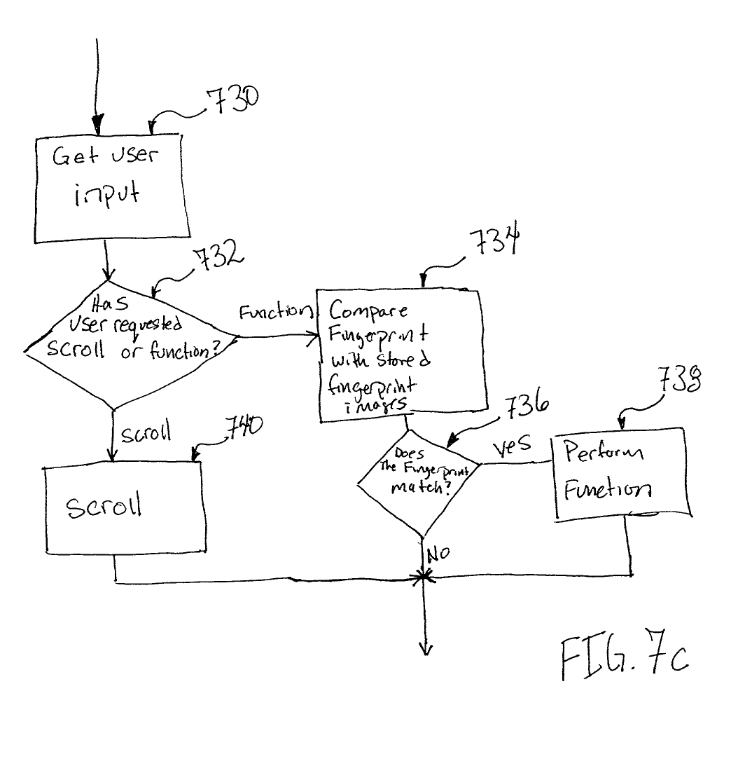

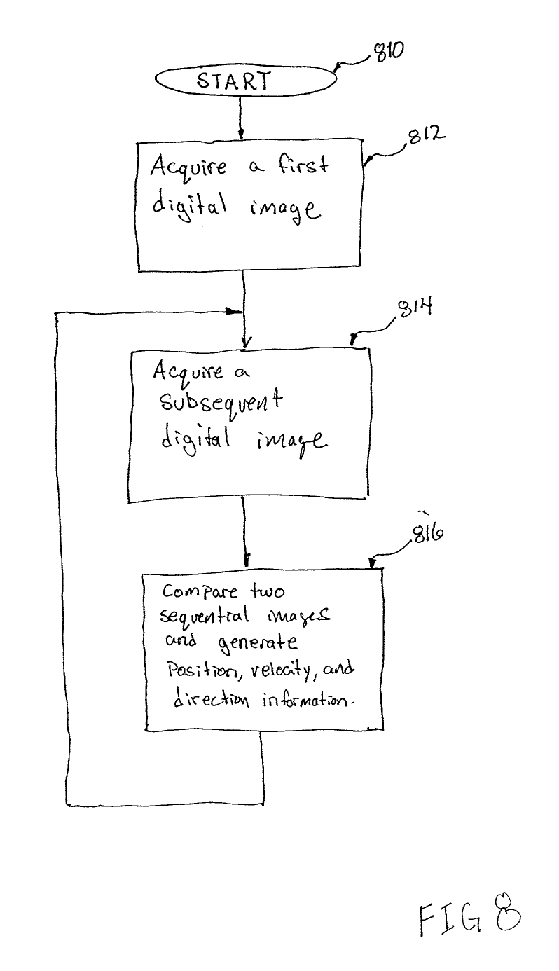

FIGS. 7A, 7B, and 7C are flowcharts illustrating various exemplary methods for determining whether the fingerprint reader 210 should be used for a scrolling/zoom function or for a hot-key function. Referring to FIGS. 6 and 7A, the flowchart of 7A is disposed within the configuration step 620 of FIG. 6. This allows the functions illustrated by FIG. 7A to be continuously invoked until the system 410 has need to switch the fingerprint reader 210 to a security mode. The first decision step in FIG. 7A is a movement detection step 710. The movement detection step 710 monitors the fingerprint reader 210 to determine if there is movement. If movement is detected, the computer system 410 moves to a scroll step 712. In the scroll step 712, the computer system 410 performs the scroll function as described in the explanation of figures above. If there is no movement detected by the movement detection step 712, the computer system 410 moves to a fingerprint compare step 714. In the fingerprint compare step 714, the computer acquires a digital image of the user's finger 314 placed on the fingerprint reader. The digital image is then compared to a variety of stored fingerprint images representing either functions or applications. After the images are compared, the computer system 410 moves into a match decision step 716. If the acquired fingerprint image of the fingerprint compare step 714 matches one of the stored fingerprint images, the system 410 moves to a perform function step 718. In the perform function step 718, the computer system 410 performs the function or launches the application associated with the matching fingerprint.

FIG. 7B illustrates an alternate method for deciding when the fingerprint reader 210 is in a scroll mode or a hot-key mode. Step 720 comprises a match determination step. The match determination step 720 acquires a digital fingerprint image from the fingerprint reader 210. The acquired fingerprint image is then compared with a collection of stored fingerprint images. If the acquired fingerprint image does not match any of the stored fingerprint images, the computer system 410 moves to a scroll mode step 722. In the scroll mode step 722, the fingerprint reader 210 monitors the movement of a finger 314 placed on the fingerprint reader 210 and translates such movement into a scroll or zoom function as explained above. If the acquired fingerprint in the match determination step 720 matches one of the stored fingerprint images, then the computer system 410 moves to the identity function step 724. In the identify function step 724, the function corresponding to the acquired fingerprint image is determined. The system 410 then moves to a scrolling decision step 726. In the scrolling decision step 726, if the function associated with the acquired fingerprint image corresponds to the scroll function, then the system 410 moves to the scroll mode step 722. If the acquired fingerprint image does not correspond to the scroll step, then the system 410 is sent to an invoke function step 728. The invoke function step 728 simply performs the function or launches the application corresponding to the acquired fingerprint. The steps outlined in FIG. 7B are disposed in the configuration step 620 set forth in FIG. 6. This allows the functions illustrated by FIG. 7B to continuously be invoked until the system 410 has need to switch the fingerprint reader to a security mode.

FIG. 7C illustrates yet another way that a computer system can utilize the fingerprint reader as both a scrolling device and hot-key select device. A first step in the method illustrated by FIG. 7C is an acquire fingerprint step 730. In the acquire fingerprint step 730, the fingerprint reader 210 acquires a digital fingerprint image from a user's finger 314 placed on the fingerprint reader 210. The computer system 410 then moves to a scroll or function decision step 732. In the scroll or function decision step 732, the computer system 410 monitors other user input to decide if the fingerprint reader 210 should be configured as a scrolling device or a hot-key device. Such user input might include simultaneous pressing of another keyboard key while placing a user's finger on the fingerprint reader for sensing or tapping on the fingerprint reader with the digit to be imaged.

If the user intends to perform a function, then the computer system 410 moves to a fingerprint analysis step 734. In the fingerprint analysis step 734, the previously acquired fingerprint is be compared with other stored fingerprint images corresponding to functions or applications. The computer system 410 then moves to a match verification step 736. If the acquired fingerprint image matched one of the stored fingerprint images, the system 410 would transition to an execute function step 738. The execute function step 738 performs the function or launch the computer application associated with the stored fingerprint image. If the match verification step 736 did not match the acquired fingerprint image with a stored fingerprint image, the system 410 proceeds to any steps following those illustrated in FIG. 7C.

Returning to the scroll or function decision step 732, if there was no external user input indicating that the user intended to perform a function, then the system 410 would move to a scrolling step 740. In the scrolling step 740, the fingerprint reader 210 is configured as a scroll device and functions as outlined previously in this disclosure. The steps outlined in FIG. 7C are disposed in the configuration step 620 set forth in FIG. 6. This allows the functions illustrated by FIG. 7C to continuously be invoked until the system 410 has need to switch the fingerprint reader to a security mode.

Turning now to FIG. 8, a method of determining velocity and direction of finger movement on a fingerprint reader is illustrated. The process is begun by acquiring the first image in the acquire first image step 812. In the acquire first image step 812, a digital image of a user's fingerprint is acquired from the fingerprint reader 210 and sent to the computer system 410. The system 410 then moves to the acquire subsequent image step 814. In the acquire subsequent image step 814, the system 410 acquires a subsequent image of the user's fingerprint after a time interval. The system 410 then moves to the generate information step 816. In the generate information step 816, the computer system 410 calculates the difference between the position of two sequential fingerprint images. Using this information in conjunction with the time interval, the computer system 410 is able to generate the velocity and direction of a user's finger 314 as it moves on the fingerprint reader 210. Alternatively, the velocity and direction information could be determined by fingerprint reader 210 firmware. The system 410 then returns to the acquire subsequent image step 814 so that the system can continuously monitor the user's finger 314 for motion.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A user input device comprising:
a fingerprint scanner; and
a driver operably coupled to the fingerprint scanner to enable the fingerprint scanner to perform a function, wherein the function comprises at least one of a scroll function, a zoom function, a hot-key function, and a select function.

2. The user input device of claim 1 wherein the fingerprint scanner comprises a CCD array.

3. The user input device of claim 1 wherein the driver is operable to configure a computer associated with the fingerprint scanner to switch between a security mode and the function.

4. The user input device of claim 1 wherein the software driver configures the computer to operate in a security mode while simultaneously performing at least one of a scroll function, a zoom function, a hot-key function, and a select function.

5. The user input device of claim 1 wherein the fingerprint scanner is disposed on a PCMCIA card.

6. The user input device of claim 1 wherein the fingerprint scanner comprises a USB interface.

7. The user input device of claim 1 wherein the fingerprint scanner is disposed on a mouse.

8. The user input device of claim 1 wherein the fingerprint scanner is disposed on a dumb terminal.

9. A computer system comprising:
a processor;
a fingerprint scanner operably coupled to the processor; and
a driver to configure the fingerprint scanner to perform at least one of a scroll function, a zoom function, a hot-key function, and a select function on the computer.

10. The computer system of claim 9 wherein the processor is disposed on a CPU.

11. The computer system of claim 10 comprising:
a first bridge unit coupled to the CPU; and
an first expansion bus coupled to the first bridge unit.

12. The computer system of claim 11 wherein the fingerprint scanner is coupled to the first expansion bus.

13. The computer system of claim 10 comprising:
a second bridge unit coupled to the first expansion bus; and
a plurality of secondary expansion busses coupled to the second bridge unit.

14. The computer system of claim 13 wherein the fingerprint scanner is disposed on at least one of the plurality of secondary expansion buses.

15. The computer system of claim 9 comprising a display coupled to the first bridge unit.

16. The computer system of claim 9 wherein the computer system is coupled for a network having a plurality of devices coupled thereto.

17. A method of operating a fingerprint scanner comprising the acts of:
(a) configuring a computer to perform at least one of a scroll function, a zoom function, a hot-key function, and a select function in response to signals generated by the fingerprint scanner; and
(b) generating signals based on input to the fingerprint scanner wherein the input to the fingerprint scanner comprises at least one of a unique image and motion.

18. The method of claim 17 comprising:
monitoring the computer system to determine if a need arises to configure the computer for security mode; and
configuring the computer for security mode when the need arises.

19. The method of claim 17 wherein act (a) comprises the act of pressing an alternate select key to configure the computer to perform at least one of the scroll function, a zoom function, a hot-key function and a select function.

20. The method of claim 17 wherein act (a) comprises the act of tapping the fingerprint reader to configure the computer to perform at least one of the scroll function, a zoom function, a hot-key function and a select function.

21. The method of claim 17 wherein act (a) comprises the act recognizing an acquired fingerprint as corresponding to the appropriate function to configure the computer to perform at least one of the scroll function, a zoom function, a hot-key function and a select function.

22. A method of manufacturing a computer system comprising the acts of:
(a) providing a fingerprint scanner;
(b) providing a processor;
(c) operably coupling the fingerprint scanner to the processor; and
(d) providing software that configures the processor to interpret signals from the fingerprint scanner as one of a scroll function, a zoom function, a hot-key function, and a select function.

23. A method of using a fingerprint scanner configurable to control one of a scroll function, a zoom function, a hot-key function, and a select function, the method comprising the act of:
moving a finger on the fingerprint scanner to cause the one of a scroll function, a zoom function, a hot-key function, and a select function.

24. The method of claim 23 comprising the act of pressing an alternate select key while simultaneously placing a finger on the fingerprint scanner.

25. The method of claim 23 comprising the act of tapping a finger on the fingerprint scanner.

26. A computer system comprising:
means for configuring a computer to perform at least one of a scroll function, a zoom function, a hot-key function, and a select function in response to signals generated by the fingerprint scanner; and means for generating signals based on input to the fingerprint scanner wherein the input to the fingerprint scanner comprises at least one of a unique image and motion.

27. A method of acquiring finger movement velocity and direction information, the method comprising the acts of:
(a) acquiring a first digital image of a fingerprint;
(b) acquiring a second digital image of a fingerprint at a specific time after acquiring the first digital image; and
(c) comparing the first and second digital images for differences to calculate velocity and direction between the first and second digital images.

28. The method of claim 27 wherein the act (c) is performed by a computer system coupled to a fingerprint reader.

29. The method of claim 27 wherein the act (c) is performed by firmware disposed in a fingerprint reader.

30. An input device comprising:
a fingerprint reader; and
a unit coupled to the fingerprint reader adapted to calculate velocity and direction based on movement of an object on the fingerprint reader.

31. The input device of claim 30 wherein the unit coupled to the fingerprint reader comprises firmware disposed in the fingerprint reader.

32. The input device of claim 30 wherein the unit coupled to the fingerprint reader comprises a processor configured by a software driver.
